(19) United States
(12) Patent Application Publication
(10) Pub. No.: US 2013/0328365 A1
(43) Pub. Date: Dec. 12, 2013

(54) ADJUSTABLE SPINE PRESSURE RELIEF APPARATUS

(71) Applicant: Chadwick W. HANNAH, Brookville, PA (US)

(72) Inventor: Chadwick W. HANNAH, Brookville, PA (US)

(21) Appl. No.: 13/855,377

(22) Filed: Apr. 2, 2013

Related U.S. Application Data
(60) Provisional application No. 61/658,514, filed on Jun. 12, 2012.

(51) Int. Cl. B60N 2/64

(52) U.S. Cl. CPC B60N 2/64
USPC 297/230.14

(57) ABSTRACT

An adjustable spine pressure relief apparatus. The apparatus can include a back support assembly, the back support assembly including a back brace reinforced with a stiffener, an adjustment assembly, the adjustment assembly including a first sliding member coupled to the back support assembly, and a second sliding member slideably engaged with the first sliding member, and a mounting assembly coupled to the second sliding member, the mounting assembly including a plurality of mounting members for attaching the mounting assembly to a portion of a vehicle seat.

### CROSS-REFERENCE TO RELATED APPLICATIONS

This application claims priority to U.S. Provisional Patent Application 61/658,514, filed Jun. 12, 2012, and entitled SPINE PRESSURE RELIEVER, the entire contents of which are hereby incorporated by reference.

### BACKGROUND

When individuals are in a seated position for extended periods of time, they can develop issues with the spine, such as lower back pain. For example, truck drivers spend many consecutive hours seated behind the wheel, and surveys have shown that a significant percentages of people treated by chiropractors for lower back pain is composed of truck drivers. Varying the amount and location of pressure on the back can mitigate the negative effects of extended sedentary positions. However, many vehicles do not provide such features, and the use of loose objects such as pillows can be uncomfortable and distracting to the driver. A solution that allows for easy mitigation of sedentary symptoms is therefore desired.

### SUMMARY

According to at least one exemplary embodiment, an adjustable spine pressure relief apparatus may be disclosed. The adjustable spine pressure relief apparatus can include a back support assembly for engaging a portion of a spine of a user, and an adjustment assembly, coupled to the back support assembly and attachable to a vehicle seat, the adjustment assembly adapted to vary the vertical position of the back support assembly in relation to the vehicle seat.

According to another exemplary embodiment, the adjustable spine pressure relief apparatus can include a back support assembly, the back support assembly including a back brace reinforced with a stiffener, an adjustment assembly, the adjustment assembly including a first sliding member coupled to the back support assembly, and a second sliding member slideably engaged with the first sliding member, and a mounting assembly coupled to the second sliding member, the mounting assembly including a plurality of mounting members for attaching the mounting assembly to a portion of a vehicle seat.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows an exemplary embodiment of a spine pressure relief apparatus.

FIG. 2 shows a back support assembly of an exemplary embodiment of a spine pressure relief apparatus coupled to a portion of a vehicle seat.

FIG. 3a is an exploded view of an armrest for an exemplary embodiment of a spine pressure relief apparatus.

FIG. 3b is an top view of a stationary rail of an armrest for an exemplary embodiment of a spine pressure relief apparatus.

FIG. 3c is an side view of an arm support of an armrest for an exemplary embodiment of a spine pressure relief apparatus.

FIG. 3d is a front view of an arm support of an armrest for an exemplary embodiment of a spine pressure relief apparatus.

FIG. 4a is an exploded view of an adjustment assembly for an exemplary embodiment of a spine pressure relief apparatus.

FIG. 4b is an top view of an outer slide of an adjustment assembly for an exemplary embodiment of a spine pressure relief apparatus.

FIG. 4c is an top view of an inner slide of an adjustment assembly for an exemplary embodiment of a spine pressure relief apparatus.

FIG. 4d is a rear view of an inner slide of an adjustment assembly for an exemplary embodiment of a spine pressure relief apparatus.

FIG. 5 is an exploded view of a mounting assembly for an exemplary embodiment of a spine pressure relief apparatus.

FIGS. 6a-6b show an adjustment assembly coupled to a mounting assembly.

FIG. 7a shows a upper belt cover and a lower belt cover for an exemplary embodiment of a spine pressure relief apparatus.

FIG. 7b shows another view of an upper belt cover for an exemplary embodiment of a spine pressure relief apparatus.

FIG. 7c is a top view of an upper belt cover for an exemplary embodiment of a spine pressure relief apparatus.

FIG. 7d is a side view of an upper belt cover for an exemplary embodiment of a spine pressure relief apparatus.

FIGS. 8a-8b show the belt covers coupled to an adjustment assembly and a mounting assembly.

FIG. 9 shows the adjustment assembly and a mounting assembly as attached to a headrest of a vehicle.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration,” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to at least one exemplary embodiment, an adjustable spine pressure relief apparatus is disclosed. Apparatus 100 may be adapted to attach to a portion of an automobile seat, such as the seatback or the headrest of the automobile seat. The spine pressure relief apparatus may further facilitate supporting portions of a user's body when the user is sitting in the automobile seat. Various portions of the spine pressure relief apparatus may be adjustable so as to provide the user with desired support and comfort. The various portions of the apparatus may further be provided with padding to facilitate user comfort.

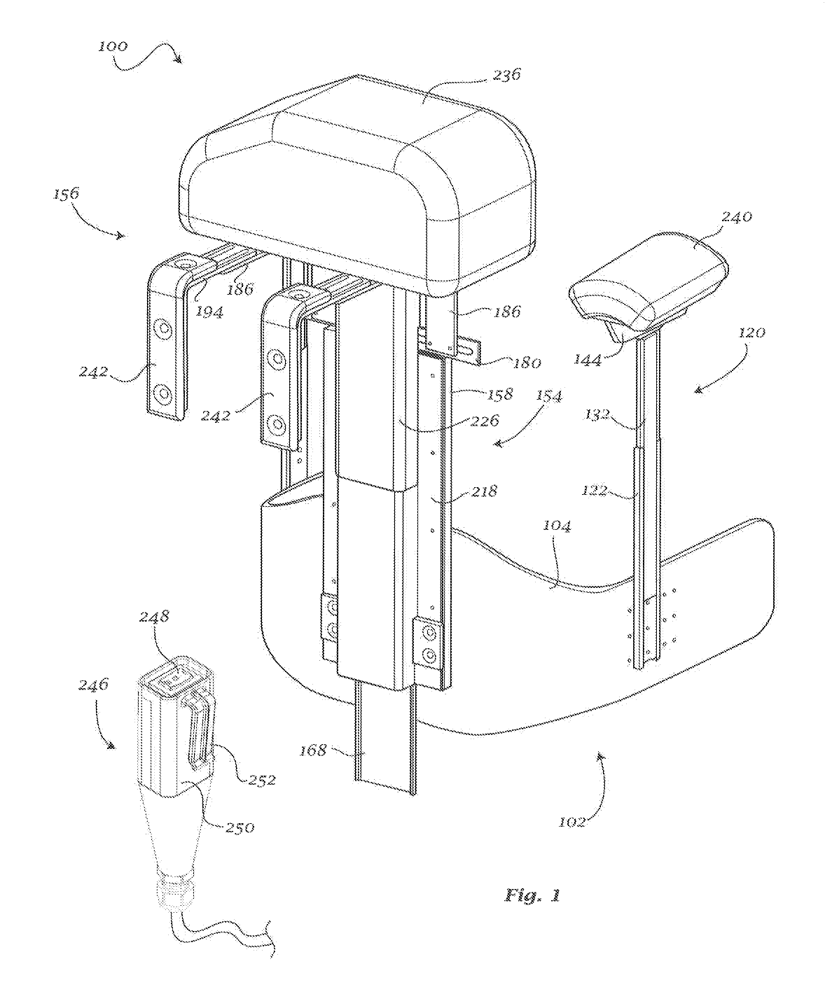

FIG. 1 shows an exemplary embodiment of a spine pressure relief apparatus 100. The spine relief apparatus 100 may include a back support assembly 102, a pair of armrests 120, an adjustment assembly 154, and a mounting assembly 156.

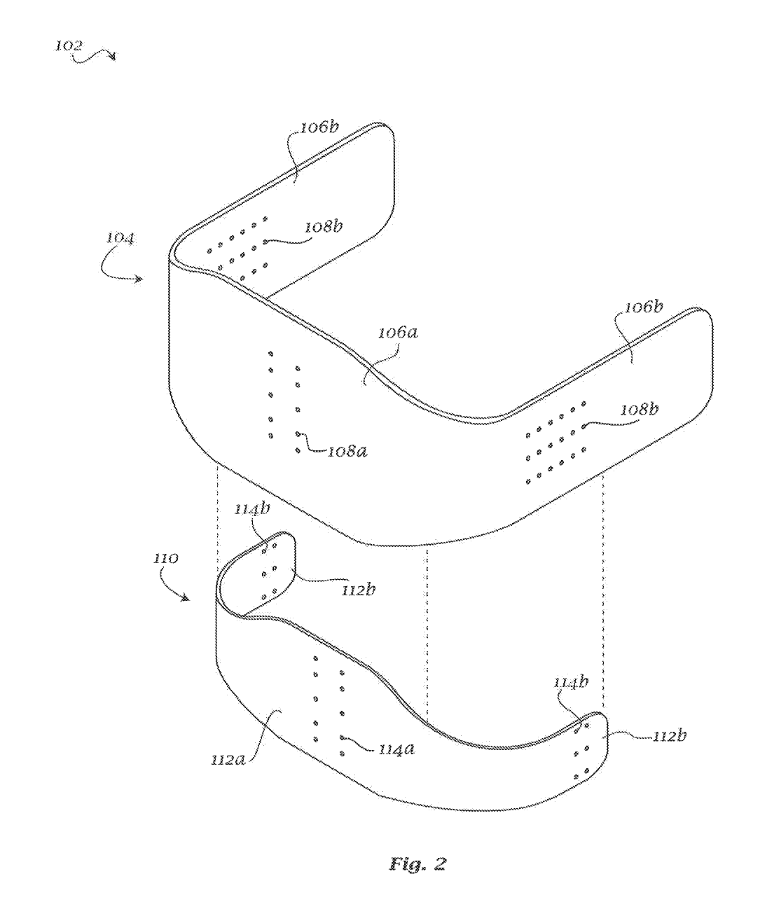

As shown in FIG. 2, the back support assembly 102 may include a lumbar back brace 104. The lumbar back brace 104 may be, for example, may be the adjustable lumbar back brace manufactured by Mueller Sport Care, or any similar lumbar back brace that enables apparatus 100 to function as described herein. Back brace 104 can have a back portion 106a and a pair of side portions 106b extending from the back portion in a substantially U-shaped configuration. Defined in back portion 106a may be a plurality of apertures 108a, while defined in each side portion 106b may also be a plurality of apertures 108b.

Back brace 104 may be reinforced by the provision of a stiffener 110. Stiffener 110 may be substantially U-shaped and may be formed from a metal such as steel, or any other suitable material. In an exemplary embodiment, stiffener 104 may have a thickness of approximately 0.125 inches and a height of approximately 6.0 inches. Similar to back brace 104, stiffener 110 can have a back portion 112a and a pair of side portions 112b extending from the back portion in a substantially U-shaped configuration. Defined in back portion 112a may be a plurality of apertures 114a, while defined in each side portion 112b may also be a plurality of apertures 114b.

The stiffener 110 may be enclosed by the back brace 104 can reinforce the back support assembly 102 so as to facilitate coupling armrests 120 and adjustment assembly 150 to the back support assembly 102. Stiffener 110 may be positioned within back brace 104 such that apertures 108a are aligned with apertures 114a, and apertures 108b are aligned with apertures 114b.

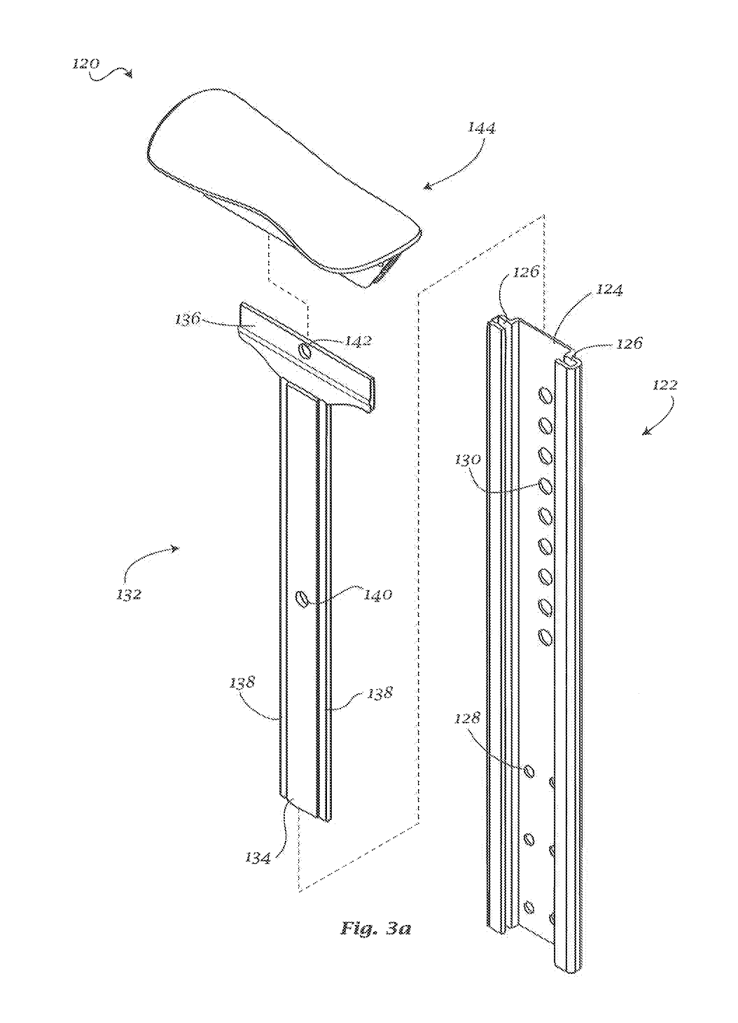

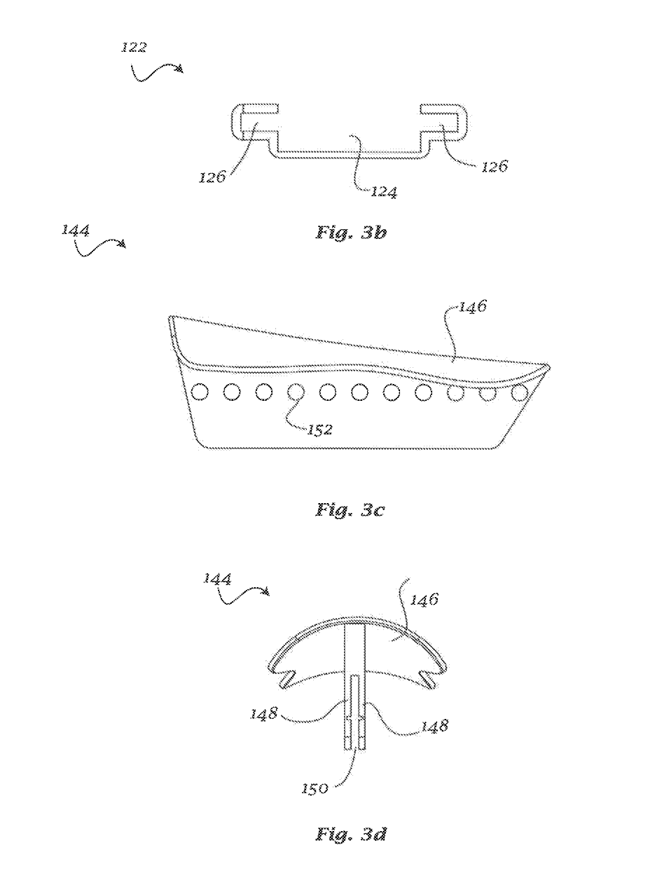

As shown in FIG. 3a, armrests 120 may include a stationary rail 122, a slideable rail 132, and an arm support 144. Stationary rail 122 may be coupled to a side portion of back support assembly 102, and slideable rail 130 may be slideably received within stationary rail 122. The arm support 140 can adjustably couple the upper portion of slideable rail 130.

Stationary rail 122 may be formed from a metal such as steel, from plastic, or from any other suitable material. A top view of stationary rail 122 is shown in FIG. 3b. The stationary rail 122 can define a central channel 124 and a pair of guide slots 126 disposed laterally to and extending along the central channel 124. In an exemplary embodiment, stationary rail 122 may have a height of about 10 inches, and a width of about 1.65 inches, while central channel 124 can have a depth of about 0.38 inches, and each guide slot 126 can have a depth of about 0.13 inches.

A plurality of coupling apertures 128 can be defined in a lower portion of stationary rail 122. The coupling apertures 128 can facilitate the coupling between armrest 120 and back support assembly 102. This coupling can be accomplished by aligning the coupling apertures 128 of armrest 120 with any desired apertures 108b, 112b, and inserting any desired fasteners into the apertures. A plurality of adjustment apertures 130 can be defined in an upper portion of stationary rail. 122. The adjustment apertures 130 can facilitate maintaining a desired position of slideable rail 132 with respect to stationary rail 122.

Slideable rail 132 may be formed from a metal such as steel, from plastic, or from any other suitable material. The slideable rail 132 can include a vertically elongated portion 134 and a horizontally elongated portion 136 coupled to an upper end of the vertically elongated portion 134. The vertically elongated portion 134 can further include a pair of flanges 138 disposed laterally to and extending along the vertically elongated portion 134. Vertically elongated portion 134 can be sized to be received within channel 124 of stationary rail 122, while flanges 138 may be sized to be received within guide slots 126 of stationary rail 122. In an exemplary embodiment, slideable rail 132 can have a height of about 13.34 inches, with the width of vertically elongated portion being about 1.53 inches, and the width of horizontally elongated portion 136 being about 4.29 inches. Furthermore, the thickness of vertically elongated portion 134 may be about 0.25 inches, with the thickness of flanges 138 being about 0.13 inches.

An vertical adjustment aperture 140 may be defined in vertically elongated portion 134. The adjustment aperture 140 can facilitate positioning slideable rail 132 with respect to stationary rail 122, by aligning aperture 140 with any desired aperture 130 of stationary rail 122. The position of the slideable rail 132 can then be maintained in place by any known fastener, for example a spring loaded button received through apertures 130, 140, or any other structure known to one skilled in the art.

An armrest coupling aperture 142 may be defined in horizontally elongated portion 136. As shown in FIGS. 3c-3d, arm support 144 can include an armrest portion 146, a pair of flanges 148 extending downwardly from arm support portion 146 and defining a channel 150 therebetween, and a plurality of armrest positioning apertures 152 defined in each flange 148. In an exemplary embodiment, arm support 144 can have a length of about 5.91 inches, and a height of about 2.06 inches, while each flange 148 may have a width of about 0.09 inches and channel 150 may have a width of about 0.14 inches.

The horizontally elongated portion 136 of slideable rail 132 can be received within channel 150 of the arm support 144. The armrest coupling aperture 142 can then be aligned with any desired pair of armrest positioning apertures 152, allowing the position of arm support 144 to be adjusted with respect to slideable rail 132. The position of the arm support 144 can then be maintained in place by any known fastener.

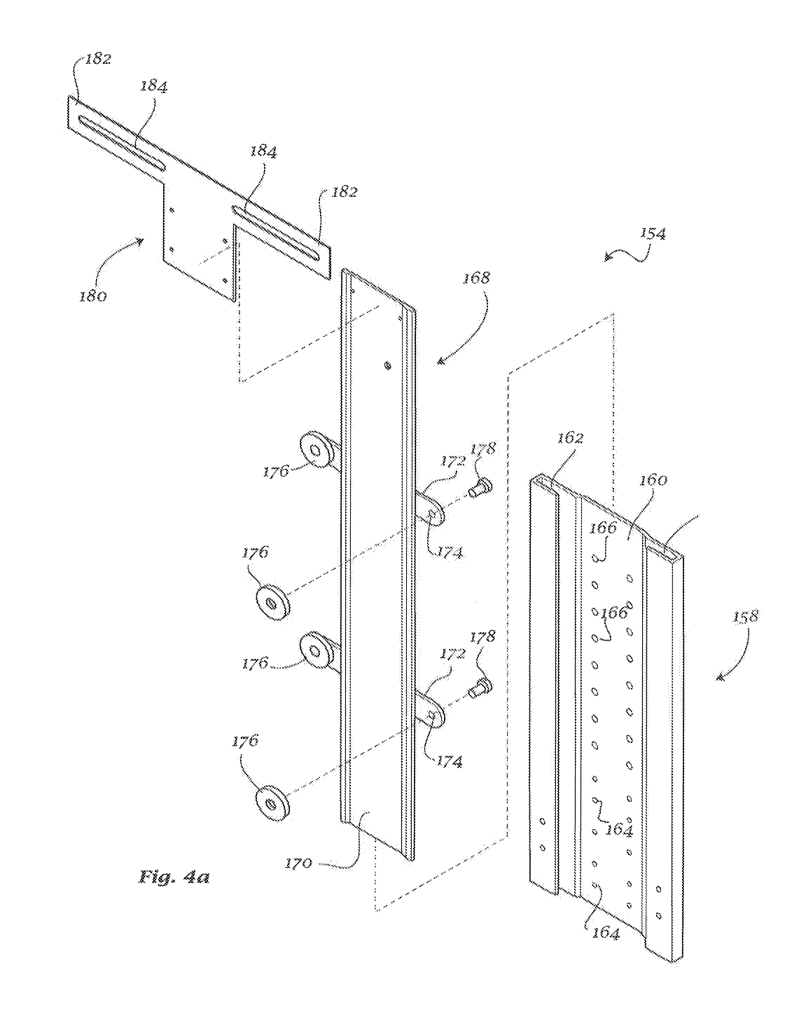

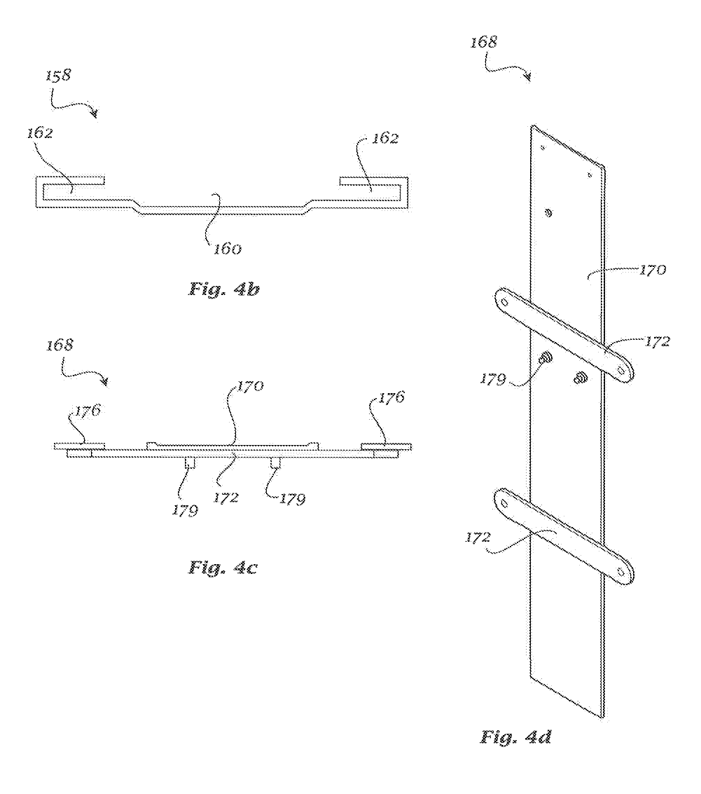

As shown in FIGS. 4a-4d, an exemplary adjustment assembly 154 can include an inner slide 168 and an outer slide 158, with inner slide 168 being slideably received within outer slide 158. The adjustment assembly 154 can couple to a mounting assembly 156 via a T-plate 180.

Outer slide may be formed from a metal such as steel, from plastic, or from any other suitable material. A top view of outer slide 158 is shown in FIG. 4b. The outer slide 158 can define a central channel 160 and a pair of guide slots 162 disposed laterally to and extending along the central channel 160. In an exemplary embodiment, outer slide 158 may have a height of about 15 inches, and a width of about 6.20 inches, while central channel 160 can have a depth of about 0.51 inches, and each guide slot 164 can have a depth of about 0.25 inches.

A plurality of coupling apertures 164 can be defined in a lower portion of outer slide 158. The coupling apertures 164 can facilitate the coupling between adjustment assembly 154 and back support assembly 102. This coupling can be accomplished by aligning the coupling apertures 164 of outer slide 158 with any desired apertures 108a, 112a, and inserting any desired fasteners into the apertures. Additionally, a plurality of positioning apertures 166 can be defined in an upper portion of outer slide 158. The positioning apertures 166 can facilitate maintaining a desired position of inner slide 168 with respect to outer slide 158.

Inner slide 168 may be formed from a metal such as steel, from plastic, or from any other suitable material. As shown in FIGS. 4a and 4c-4d, the inner slide 168 can include a vertically elongated portion 170 and a pair of transverse arms 172 coupled to a coupled to a first surface of the vertically elongated portion 170. Each transverse arm 172 can include an aperture 174 defined in each end thereof. A slide wheel 176 may be coupleable to each end of an arm 172 by insertion of a wheel axle 178 thru aperture 174 and coupling of the wheel axle 178 to the slide wheel 176.

Vertically elongated portion 170 can be sized to be received within channel 160 of outer slide 150, while the ends of arms 172 as well as wheels 176 may be sized to be received within guide slots 162 outer slide 158. When inner slide 168 is received within outer slide 158, wheels 176 can engage the walls of guide slots 162 so as facilitate smooth slideable movement of slides 158. 168 with respect to each other. Vertically elongated portion 170 can further include a pair of spring loaded buttons 179 disposed on the first surface thereof. The spring-loaded buttons 179 can engage positioning apertures 166 so as to facilitate maintaining inner slide 168 at a desired positing. The spring-loaded buttons 179 can further have a chamfered edge so as to allow the buttons to easily disengage from apertures 166 when inner slide 168 is moved by the user.

In an exemplary embodiment, vertically elongated portion 170 can have a height of about 20 inches and a width of about 3 inches. Transverse arms 172 can have a height of about 0.80 inches, a length of about 5.75 inches, and a thickness of about 0.13 inches.

Coupled to an upper end of vertically elongated portion 170 may be a connecting T-piece 180. T-piece 180 may be substantially T-shaped, with the post thereof being coupled to vertically elongated portion 170. Coupling may be facilitated by fasteners, rivets, or any other manner of coupling known in the art. The upper portion of T-piece 180 can include a pair of arms 182 extending laterally outward in the plane of T-piece 180. Each arm 182 may include a horizontally elongated slot 184 defined therein.

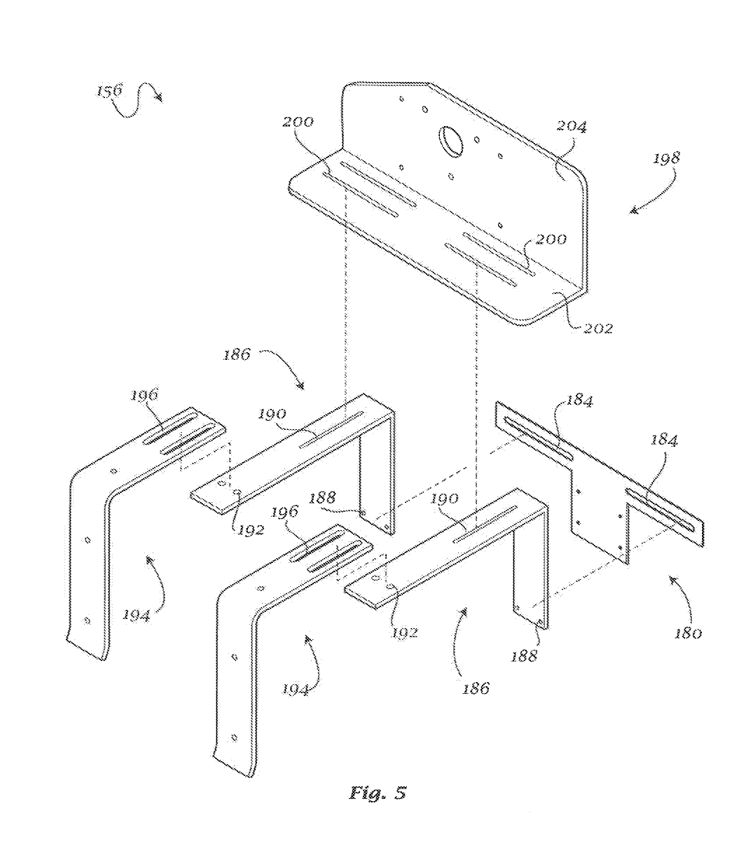

T-plate 180 can serve to couple adjustment assembly 154 to mounting assembly 156. As shown in FIG. 5, the mounting assembly 156 can include a pair of first mounting brackets 186, a pair of second mounting brackets 194, and a motor mount 198. A a motor 206 may be coupled to motor mount 198.

Coupled to each horizontal slot 184 of T-piece 180 may be a first mounting bracket 186. The first mounting bracket 185 may be substantially L-shaped. The lower, vertically extending portion of first mounting bracket 186 may couple to T-piece 180 by way of fasteners received thru apertures 188 defined in the vertically extending portion first mounting bracket 186 and through slots 184 of T-piece 180. The elongated configuration of slots 184 can allow the position of first mounting brackets 186 to be adjusted with respect to T-piece 180 and to each other. Defined in the upper, horizontally extending portion of first mounting bracket 186 may be an elongated slot 190 and a pair of apertures 192.

Coupled to first, mounting bracket 185 via apertures 192 may be a second mounting bracket 194. The second mounting bracket 194 may be substantially L-shaped. Defined in the upper, horizontally extending portion of second mounting bracket 194 may be a pair of elongated slots 196. The upper, horizontally extending portion of second mounting bracket 194 may couple to first mounting bracket 186 by way of fasteners received thru apertures 192 defined in the horizontally extending portion of first mounting bracket 186 and through slots 196 of second mounting bracket 194. The elongated configuration of slots 196 can allow the position of the second mounting brackets 194 to be adjusted with respect to first mounting bracket 186.

Coupled to first mounting brackets 186 via slots 190 may be a motor mount 198. The motor mount 198 can include a lower, horizontally extending plate 202 and a vertically extending plate 204. Defined in the lower plate 202 may be a plurality of elongated slots 200. The motor mount can couple first mounting brackets 186 by way of fasteners received through slots 200 of the motor mount and slots 190 of the first mounting brackets 186. The elongated configurations of slots 190 and 200 can allow the position of motor mount 198 to be adjusted with respect to first mounting brackets 186. A plurality of apertures may be defined in the vertically extending plate 204 for coupling motor 206, upper pulley 208, and upper belt cover 226 to the motor mount 198.

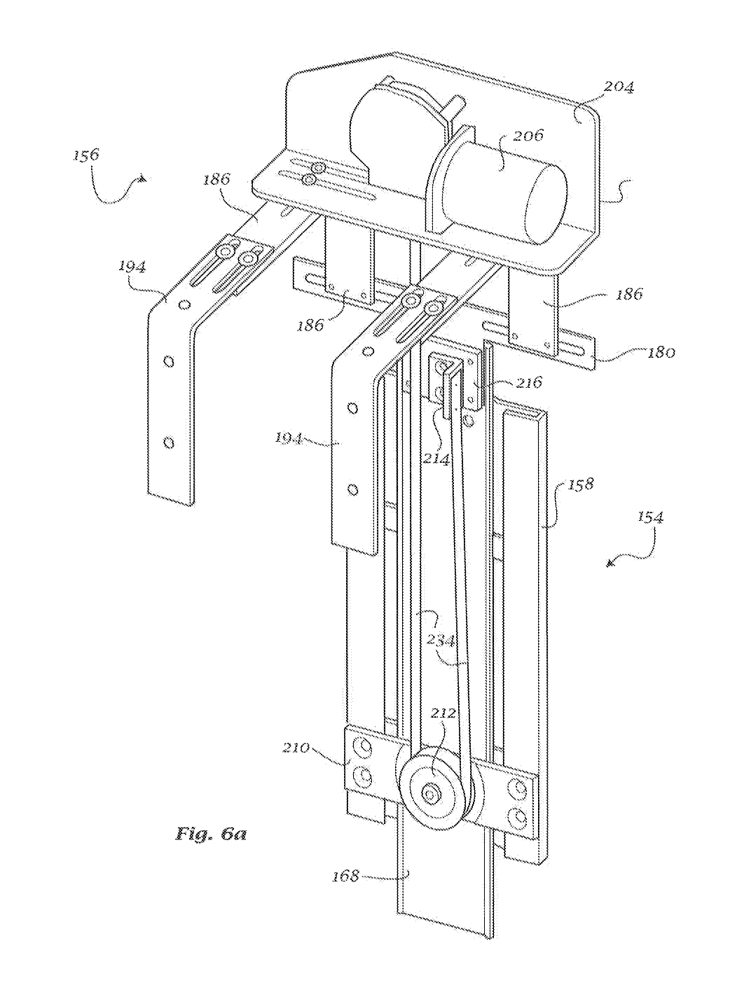

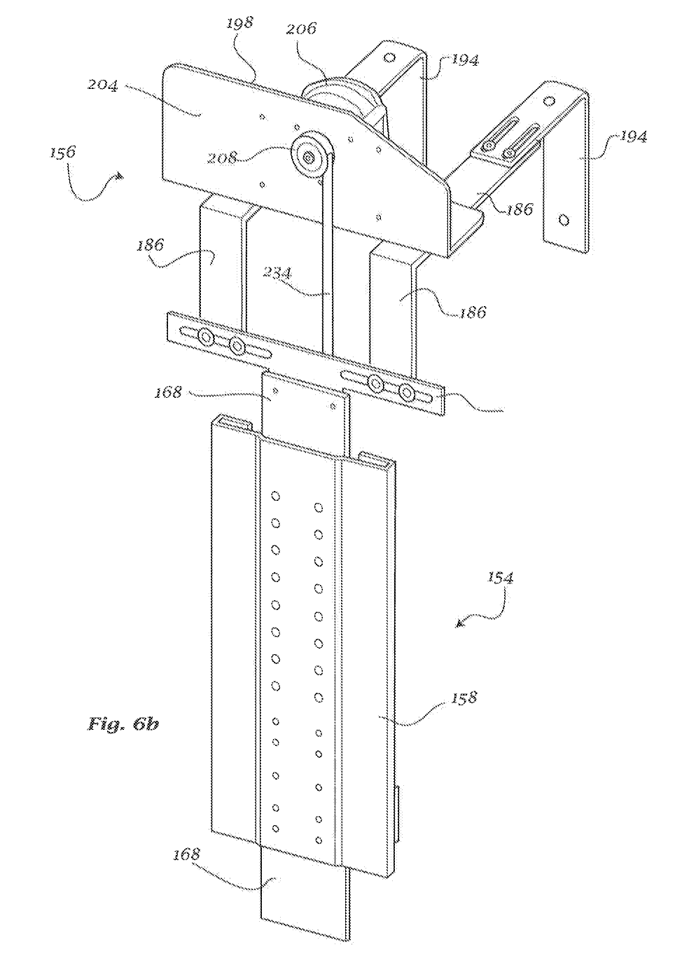

FIGS. 6a-6b show adjustment assembly 154 coupled to mounting assembly 156. A motor 206 may be coupled to vertically extending plate 204 of motor mount 198. Motor 206 may drive an upper pulley 208 disposed on an opposite face of the vertically extending plate 204. In an exemplary embodiment, upper pulley 208 may be a 16 tooth, 1.019 pitch diameter pulley adapted for a 0.156 pitch belt.

Coupled to a bottom portion of outer slide 158 may be a pulley mount plate 210. Rotatably coupled to the pulley mount plate 210 may be a lower pulley 212. In an exemplary embodiment, lower pulley 212 may be a 32 tooth, 2.037 pitch diameter pulley adapted for a 0.156 pitch belt.

Lower pulley 212 may be substantially vertically aligned with upper pulley 208, and may be operatively coupled thereto by a belt 234. A first end of belt 234 may be fixedly coupled to upper pulley 208. Coupled to T-piece 180, or alternatively, to an upper portion of inner slide 168 may be a belt holder mount 214. Coupled to the holder guide mount 214 may be a belt holder 216, which may be L-shaped. A second end of belt 234 may be fixedly coupled to belt holder 216. Consequently, the operation of motor 206 can serve to vertically displace outer slide 158 in relation to inner slide 168. Furthermore, since apparatus 100 can be attached to a headrest of an vehicle via second mounting brackets 194 and first mounting brackets 186 of mounting assembly 156, and as back support assembly 102 is coupled to outer slide 158, the operation of motor 206 can raise and lower the back support assembly 102 and armrests 120 with respect to the seat of the vehicle.

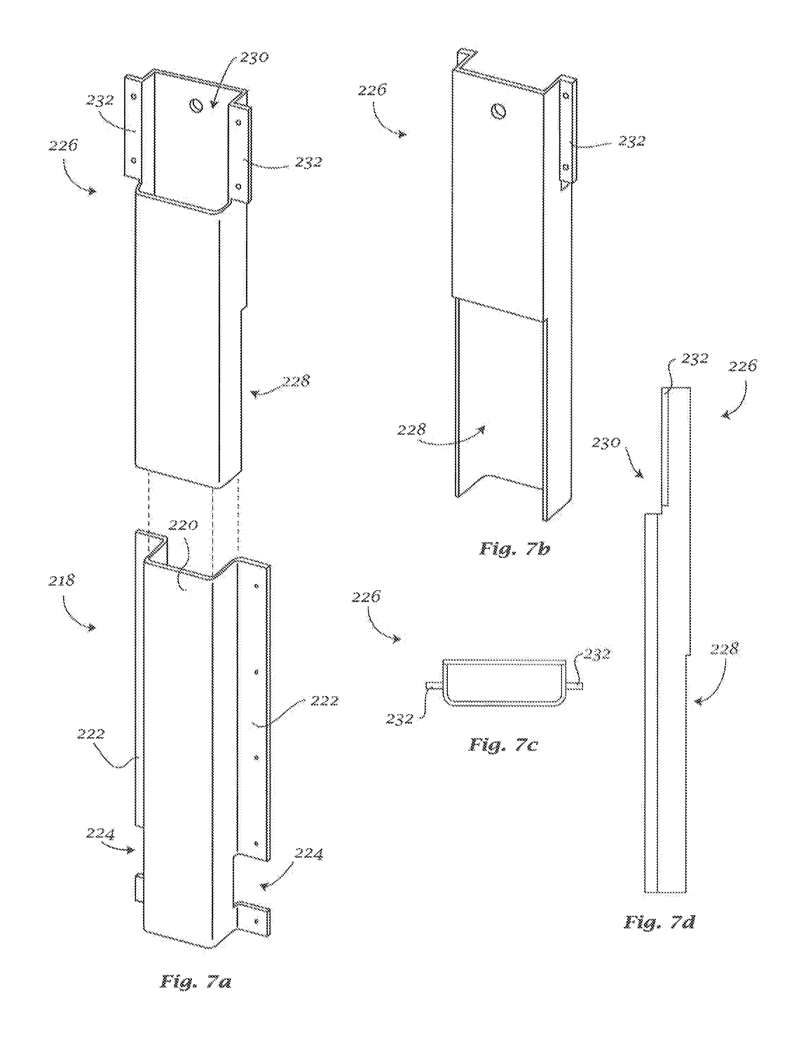

The belt, as well as portions of adjustment assembly 154 and mounting assembly 156 may be enclosed by an upper belt cover 226 and a lower belt cover 218, which are shown in FIGS. 7a-7d. The lower belt cover can have a U-shaped central portion 220 and a pair of flanges 222 disposed laterally to and extending along the central portion 220. The flanges 222 can serve to couple lower belt cover 218 to outer slide 158. A cutout 224 may be provided in each flange to receive a portion of pulley mount plate 210. In an exemplary embodiment, lower belt cover 218 can have a height of approximately 15 inches, a width of approximately 6.2 inches, and a depth of approximately 1.28 inches.

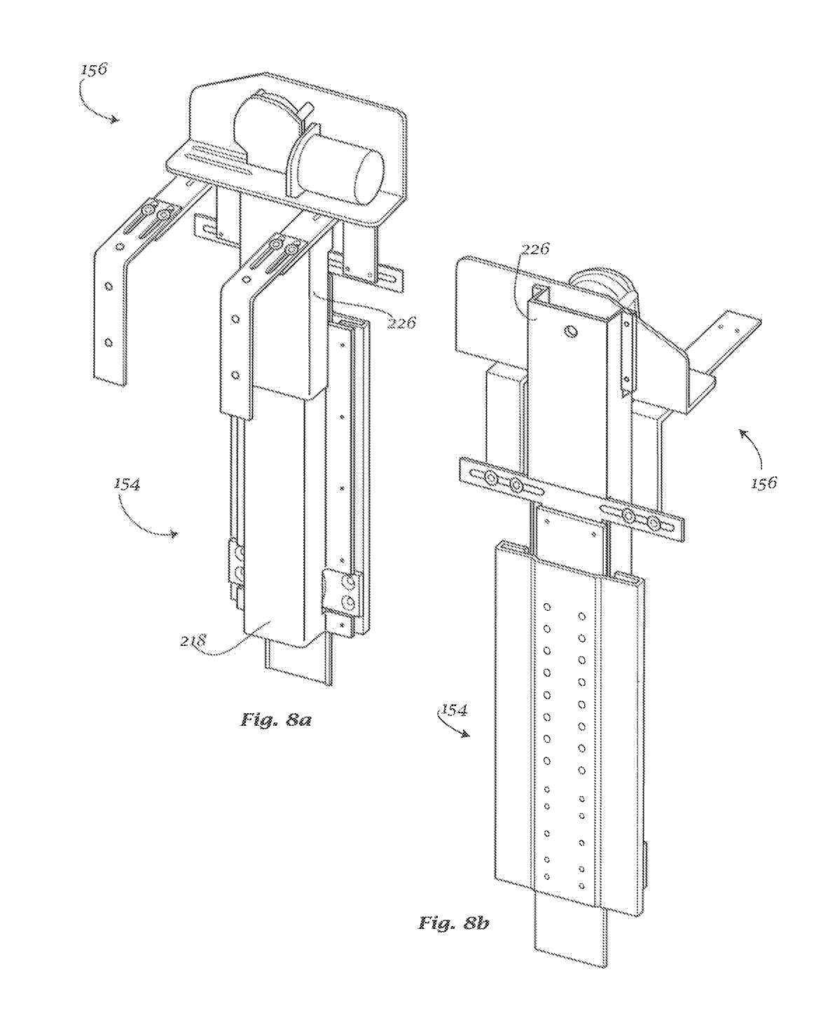

The upper belt cover 226 can include two pairs of opposing sidewalls enclosing a hollow cavity. The upper belt cover 226 can further include a lower cutout 228, an upper cutout 230 and flanges 232. Lower cutout 228 may be sized so as to slideably receive a portion of central portion 220 of lower belt cover 218 therein. Flanges 232 can couple to the vertically extending plate 204 of motor mount 198, and upper cutout 230 can allow the belt to access the upper pulley 208. FIGS. 8a-8b show an exemplary adjustment assembly 154 with upper belt cover 226 and lower belt cover 218 coupled thereto so as to enclose the belt 234 and portions of the adjustment assembly 154 and mounting assembly 156.

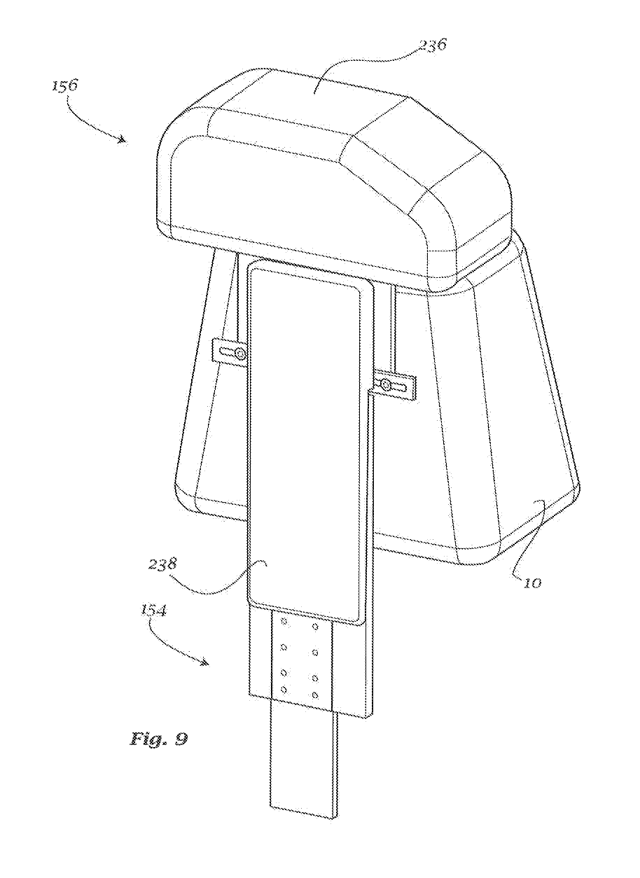

Portions of spine pressure relief apparatus 100 may be provided with padding so as to provide a comfortable contact surface for the user. As shown in FIGS. 1 and 9, mounting assembly 156 may be covered with a mounting assembly cover pad 236. The mounting assembly cover pad 236 can serve to enclose to components of mounting assembly 156, as well as to provide a soft or resilient surface to support the head and neck of the user. The surface of outer slide 158 that is facing the user can be covered by a back pad 238, so as to provide a soft and resilient surface to contact the neck and upper back of the user. Each armrest portion 146 can he provided with an armrest pad 240, so as to provide a soft and resilient surface to support the arms of the user. Finally, second mounting brackets 160 can include second mounting bracket pads 242, so as to provide soft and resilient surfaces in the event of contact between the second mounting brackets and an individual. The pads 236, 238, 240, 242 may be formed from high-density foam and covered in vinyl, or may be formed from any material that enables apparatus 100 to function as described herein.

Turning to FIG. 1, apparatus 100 can further include switch assembly 246, which can include a switch 248 disposed within a housing 250. Switch 248 may be operatively coupled to motor 206. Switch 248 may be recessed within the housing so as to facilitate avoiding accidental activation of the motor. Switch 248 may be, for example, a three way rocker switch, allowing the user to activate the motor in a first direction, or a second direction. Releasing the switch can cease operation of the motor. Switch assembly 246 may be operatively connected to motor 206 in any known manner, for example via a cable. Housing 250 can further include a clip 252, allowing the user to affix the switch assembly to a seat belt or to any other suitable structure.

In some exemplary embodiments, electrical power may be provided to apparatus via a standard lighter socket adapter. Apparatus 100 may therefore be adapted to operate on 12-volt direct current sourced from the electrical system of the vehicle. In other exemplary embodiments, apparatus 100 may include batteries in lieu of or in addition to the lighter socket adapter.

The adjustability of the positions first mounting brackets 186, second mounting brackets 194, and motor mount 198 can allow apparatus 100 to be coupled to a variety of seats and headrests. In operation, the user may loosen the fasteners connecting components 186, 194 and 198 to each other, as well as the fasteners connecting first mounting brackets 186 to T-piece 180. The user can then adjust the spacing of components 186, 194 and 198 by use of the elongated slots defined therein, thereby allowing a seat portion of desired size to be received therebetween. The adjustment assembly 254 is shown coupled to a headrest 10 of a vehicle in FIG. 9. Alternatively, components 186, 194, and 198 may be adjusted such that the spacing therebetween is suitable to receive an upper back portion of a vehicle seat.

Once apparatus 100 is coupled to a vehicle seat, the user may connect apparatus 100 to electrical power and operate the motor so as to place back brace assembly 102 in a comfortable position relative to the user's back. The user may further adjust the horizontal and vertical positions of armrests 120 to a comfortable position. Electric operation can allow the user to easily vary the position of the back support assembly 102, and thereby adjust the amount and position of pressure on the user's spine. Apparatus 100 can thus provide relief for back pain or other discomfort when the user spends an extended time in a vehicle seat. Once apparatus 100 is put in place and adjusted as desired, the apparatus can significantly reduce the subjection of the spine to pressure resulting from sitting.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An adjustable spine pressure relief apparatus, comprising:
a back support assembly for engaging a portion of a spine of a user; and
an adjustment assembly, coupled to the back support assembly and attachable to a vehicle seat, the adjustment assembly adapted to vary the vertical position of the back support assembly in relation to the vehicle seat.

2. The apparatus of claim 1, further comprising a pair of armrests coupled to the back support assembly.

3. The apparatus of claim 1, the back support assembly comprising a back brace reinforced with a stiffener.

4. The apparatus of claim 1, wherein the back support assembly is substantially U-shaped.

5. The apparatus of claim 1, the adjustment assembly comprising:
a first sliding portion coupled to the back support assembly;
a second sliding portion slideably engaged with the first sliding portion; and
a mounting assembly coupled to the second sliding portion, the mounting assembly being attachable to a vehicle seat.

6. The apparatus of claim 5, the adjustment assembly further comprising:
a first pulley coupled to the first sliding portion;
a second pulley coupled to the mounting assembly; and
a belt extending between and operatively coupled to the first pulley and the second pulley.

7. The apparatus of claim 6, further comprising a bidirectional motor for driving the second pulley.

8. The apparatus of claim 7, further comprising a user operable switch operatively coupled to the motor.

9. The apparatus of claim 6, the apparatus being adapted to couple to a vehicle electrical system.

10. An adjustable spine pressure relief apparatus, comprising:
a back support assembly, the back support assembly including a back brace reinforced with a stiffener;
an adjustment assembly, the adjustment assembly including a first sliding member coupled to the back support assembly, and a second sliding member slideably engaged with the first sliding member; and
a mounting assembly coupled to the second sliding member, the mounting assembly including a plurality of mounting members for attaching the mounting assembly to a portion of a vehicle seat.

11. The apparatus of claim 10, further comprising:
a first pulley coupled to the first sliding portion;
a second pulley coupled to the mounting assembly; and
a belt extending between and operatively coupled to the first pulley and the second pulley.

12. The apparatus of claim 11, further comprising a bidirectional motor for driving the second pulley.

13. The apparatus of claim 12, further comprising a user operable switch operatively coupled to the motor.

14. The apparatus of claim 10, wherein the mounting members are adjustable.

15. The apparatus of claim 10, wherein the plurality of mounting members comprises a pair of first mounting members and a pair of second mounting members, each second mounting member being coupled to a first mounting member.

16. The apparatus of claim 15, wherein the pair of first mounting members and the pair of second mounting members define a space therebetween for receiving a portion of a vehicle seat.

17. The apparatus of claim 16, wherein the pair of first mounting members and the pair of second mounting members are adjustable so as to vary the dimensions of the space defined therebetween.

18. The apparatus of claim 10, further comprising a pair of armrests coupled to the back support assembly.

19. The apparatus of claim 18, wherein the height of each armrest is adjustable.

20. An adjustable spine pressure relief apparatus, comprising:
back supporting means for engaging a portion of a spine of a user;
mounting means for attaching the apparatus to a portion of a vehicle seat; and
adjustment means for varying the distance between the back supporting means and the mounting means.
